(19) United States
(12) Patent Application Publication
(10) Pub. No.: US 2020/0310096 A1
(43) Pub. Date: Oct. 1, 2020

(54) SYSTEMS FOR FLUORESCENCE LIGHT SHEET MICROSCOPY OF LARGE SAMPLES IN HIGH REFRACTIVE INDEX SOLUTIONS

(71) Applicants: THE REGENTS OF THE UNIVERSITY OF CALIFORNIA, Oakland, CA (US); TRANSLUCENCE BIOSYSTEMS, INC., Irvine, CA (US)

(72) Inventors: Sunil Gandhi, Irvine, CA (US); Ricardo R Azevedo, Irvine, CA (US); Damian Wheeler, Irvine, CA (US)

(21) Appl. No.: 16/832,532

(22) Filed: Mar. 27, 2020

Related U.S. Application Data
(60) Provisional application No. 62/825,232, filed on Mar. 28, 2019.

(51) Int. Cl. G02B 21/16; G02B 21/24; G01N 21/64

(52) U.S. Cl. CPC G02B 21/16; G02B 21/241; G01N 2201/063; G01N 2021/6463; G01N 21/6458

(57) ABSTRACT

Systems for allowing imaging of large specimens in high refractive index solutions, such as those with a refractive index of at least 1.45, for use in microscopes such as fluorescent light sheet microscopes. The systems allow for imaging large specimens in high RI while maintaining the highest optical sectioning provided by the objectives used across the full range of microscope stage travel. The systems also allow the use of a wider range of optics, such as low magnification 2.5× detection objectives, allowing for increased imaging speed and field of view.

### CROSS-REFERENCES TO RELATED APPLICATIONS

This application is a non-provisional and claims benefit of U.S. Provisional Application No. 62/825,232 filed Mar. 28, 2019, the specification of which is incorporated herein in its entirety by reference.

### STATEMENT REGARDING FEDERALLY SPONSORED RESEARCH OR DEVELOPMENT

A portion of this invention was made with government support under Grant No. DP2EY024504-01 awarded by NIH. The government may have certain rights in the invention.

### FIELD OF THE INVENTION

The present invention is directed to light sheet fluorescence microscopy for the imaging of biological samples. Specifically, the present invention is directed to light sheet fluorescence microscopy for the imaging of biological samples in high refractive index solutions.

### BACKGROUND OF THE INVENTION

Light sheet fluorescence microscopy is a growing practice in the field of optical imaging of tissue samples and is defined by the concept of completely separating the detection pathway of a microscope from the sample illuminating pathway of the microscope. A light sheet fluorescence microscope illuminates a thin layer (100 nm to 1 μm tall) of a sample, such that the focal plane of a detection objective is perpendicular to the thin layer of light. This technique is designed for efficient optical sectioning and provides for fast imaging speed. However, such light sheet fluorescence microscopes may struggle with efficiently imaging samples with a high refractive index (RI).

Existing chambers for such microscopes, such as the Z.1 fluorescence light sheet microscope, are typically designed for imaging of biological samples in aqueous solutions of RI<=1.45. Using these chambers with high RI solutions results in mispositioned excitation light sheets that limit the optical resolution and effective imaging area on the Z1 system. Therefore, a present need exists for a light sheet fluorescence microscopy system capable of efficiently imaging biological samples in high RI solutions.

### BRIEF SUMMARY OF THE INVENTION

It is an objective of the present invention to provide systems that allow for light sheet fluorescence microscopy of biological samples in high RI solutions, as specified in the independent claims. Embodiments of the invention are given in the dependent claims. Embodiments of the present invention can be freely combined with each other if they are not mutually exclusive.

The present invention features a specimen imaging system for use in a fluorescence light sheet microscope for producing an image of a large specimen in a high refractive index solution (e.g., a solution having a refractive index (RI) of at least 1.45). In some embodiments, the system comprises a specimen chamber for accommodating a tissue; a first and a second side window for a light sheet, spaced to center a beam waist at a detection optic focal plane; a chamber positioning mechanism for facilitating adjustment of an imaging objective focal plane according to the refractive index of the high refractive index solution; a specimen holder for suspending large tissue specimens within the chamber; and a detection objective collar for repositioning an objective's focal plane to increase imaging range and match the focal plane of the light sheet, wherein the collar also prevents accidental collision with the specimen chamber during positioning.

In some embodiments, a volume of the tissue is approximately 1 cm³. In some embodiments, the tissue is 1 cm³ or more. In some embodiments, the tissue is from 0.5 cm³ to 2 cm³.

In some embodiments, the fluorescence light sheet microscope is a Zeiss Z1 Fluorescence Light Sheet Microscope.

While prior fluorescence light sheet microscopy systems are limited in the size of the specimen being imaged, the present invention makes use of a larger specimen chamber size and low magnification objectives to allow imaging of overall larger specimens. Prior fluorescence light sheet microscopy systems additionally struggle with imaging specimens in aqueous solutions with a high refractive index.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a detailed view of components of the system of the present invention.

FIG. 2A shows a front view of the system of the present invention.

FIG. 2B shows a side view of the system of the present invention.

FIG. 2C shows a top view of the system of the present invention.

FIG. 2D shows an isometric view of the system of the present invention.

FIG. 3 shows a flow chart of a method of the present invention.

FIG. 4 shows an embodiment of the present invention.

### DETAILED DESCRIPTION OF THE INVENTION

Following is a list of elements corresponding to a particular element referred to herein:

1 specimen chamber

2 side windows

3 window seal

4 chamber positioning screw

5 specimen holder

6 detection objective collar

20 beam waist

25 detection optic focal plane

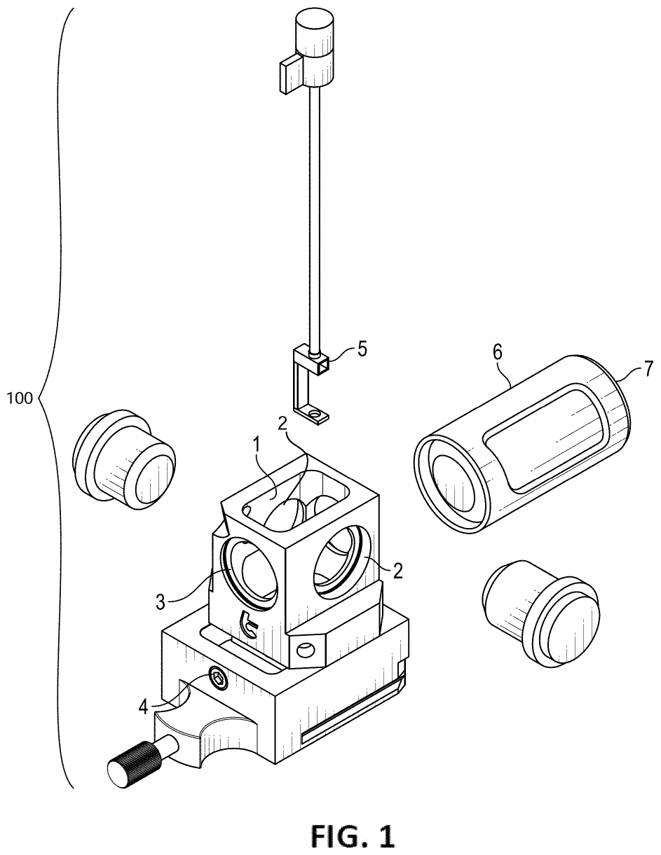

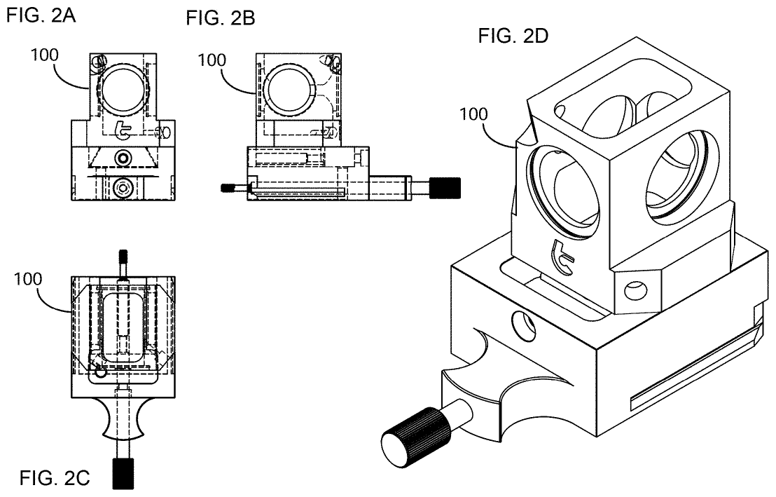

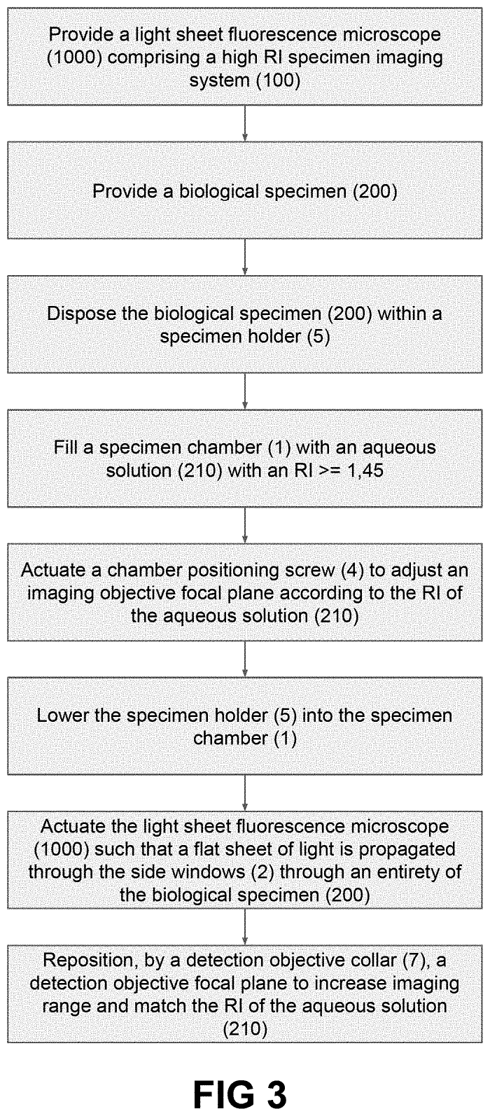

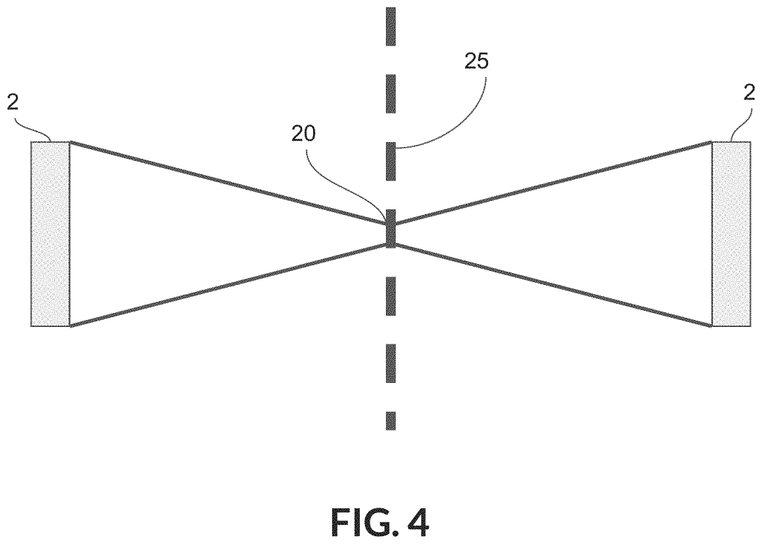

Referring now to FIG. 1, FIG. 2, and FIG. 3, the present invention features a specimen imaging system. The system of the present invention increase imaging speed for large samples by facilitating the use of low magnification detection objectives (e.g., 2.5×); improve optical sectioning in high refractive index solutions; increase the chamber volume and modify detection path focal length, thereby increasing the size of specimens that can be imaged; and provide a new specimen mounting mechanism to accommodate larger samples.

The aforementioned features are accomplished through a combination of repositioned light sheet path windows, adjusted path length to the imaging objective, improved integrity of window seals to prevent leaks, optimized overlap between light sheet and imaging objective focal planes through hardware and software adjustments, and new specimen mounting hardware.

The systems of the present invention may be used with appropriate microscopes such as the Zeiss Z1 Fluorescence Light Sheet Microscope.

Referring to FIG. 1 and FIG. 2, a specimen chamber (1) accommodates full stage travel of large tissue up to ˜1 cm³ (e.g., for whole mouse brains). A first and a second side window (2) for the light sheets are positioned on either side of the specimen chamber (1) and are spaced to center a beam waist (20) of a light sheet focal plane at a detection optic focal plane (25). The detection optic focal plane (25) may be a viewable range of a microscope. The light sheet focal plane may be a plane of illumination of the microscope. Centering the beam waist (20) at the detection optic focal plane (25) allows microscope viewability at a point of light sheet focus. A window seal (3) design (including gaskets) may be made of immersion-solvent resistant materials to prevent leaks and positioned around the first side window and the second side window (2). A chamber positioning screw (4) operatively connected to the specimen chamber (1) may facilitate adjustment of the imaging objective focal plane according to the refractive index of the immersion solvent. A specimen holder (5) may be removably disposed above the specimen chamber (1) and may be designed to suspend large tissue specimens up to ˜1 cm³ in the specimen chamber (1). A detection objective collar (6) prevents accidental collision with the specimen chamber during positioning. The detection objective collar (6) repositions the objective's focal plane to increase imaging range and match the refractive index of the immersion solvent.

The present invention features systems for enabling the use of the Zeiss Z.1 fluorescence light sheet microscope (or other appropriate microscope) for imaging specimens in high refractive index solutions with a refractive index (RI) of at least 1.45. Tissue clearing strategies make it possible to image deep into complex tissues, such as whole mouse brains, by rendering the tissue optically transparent. The systems of the present invention allow for a flat, thin beam of light to illuminate large biological tissues previously unachievable by the existing Zeiss system. The imaging chamber will increase the 1) speed, 2) spatial resolution and 3) specimen size for fluorescence light sheet imaging on the Z1 system for high refractive index cleared specimens (e.g., for solutions with a refractive index (RI) of at least 1.45).

The systems of the present invention feature optical paths optimized for high RI solutions, larger chambers for fitting larger tissues such as whole mouse brains, a leak resistant window, an added positioner for centering the light sheet in the sample, and an objective safety collar for preventing collision with the chamber. Optionally, sample holders may be featured.

In some embodiments, the systems of the present invention are used for obtaining high resolution, fast 3-D imaging of brain samples. However, the present invention is not limited to this particular application.

In some embodiments, the system increases imaging speed for large samples. In some embodiments, the system facilitates use of low magnification detection objectives. In some embodiments, the system improves optical sectioning in high refractive index solutions. In some embodiments, the system has an increased chamber volume as compared to traditional chambers. In some embodiments, the system has an increased detection path focal length to increase the size of specimens that can be imaged.

Referring now to FIG. 3, the present invention features a method of light sheet fluorescence microscopy for imaging a biological specimen (200) in a high refractive index solution (210). In some embodiments, the method may comprise providing a light sheet fluorescence microscope (1000) with a high refractive index specimen imaging system (100). The light sheet fluorescence microscope (1000) may be a Zeiss Z1 Fluorescence Light Sheet Microscope. The method may further comprise providing a biological specimen (200) and disposing the biological specimen (200) within a specimen holder (5). In some embodiments, the biological specimen (200) is 1 cm³ or more in size. In some embodiments, the biological specimen (200) is between 0.5 cm³ to 2 cm³ in size. The method may further comprise filling a specimen chamber (1) with an aqueous solution (210) with a refractive index>=1.45. The method may further comprise actuating a chamber positioning screw (4) to adjust an imaging objective focal plane according to the refractive index of the aqueous solution (210). The specimen holder (5) may then be lowered into the specimen chamber (1). The light sheet fluorescence microscope (1000) may then be actuated such that a flat sheet of light is propagated through a first and a second side window (2) and through an entirety of the biological specimen (200). The side windows (2) may be capable of centering a beam waist of the light sheet at a focal plane of a detection optic. The method may further comprise using a detection objective collar (7) to reposition a detection objective focal plane to increase imaging range and match the refractive index of the aqueous solution (210). In some embodiments, the light sheet fluorescence microscope (1000) may facilitate use of low magnification detection objectives and improve optical sectioning in high refractive index solutions. The chamber volume of the high refractive index imaging system (100) may be an increased chamber volume as compared to traditional chambers. The high refractive index imaging system (100) may have an increased detection path focal length to increase the size of specimens that can be imaged.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A specimen imaging system (100) for use in a fluorescence light sheet microscope (1000) to produce an image of a tissue (200) in a high refractive index solution (210), the system comprising:
a. a specimen chamber (1) for accommodating a tissue (200);
b. a first and second side window (2) positioned on either side of the specimen chamber (1), wherein the side windows (2) are spaced to center a beam waist of a light sheet at a focal plane of a detection optic;
c. a chamber positioning mechanism (4) operatively connected to the specimen chamber (1) for facilitating adjustment of a detection objective focal plane (25) according to the refractive index of the high refractive index solution (210);
d. a specimen holder (5) removably positioned above the specimen chamber (1) for suspending the tissue (200) within the chamber (1); and
e. a detection objective collar (7) for repositioning the detection objective focal plane (25) to increase imaging range and match a light sheet focal plane, wherein the collar (7) also prevents accidental collision with the specimen chamber (1) during positioning.

2. The system of claim 1, wherein the high refractive index solution (210) has a refractive index (RI) of at least 1.45.

3. The system of claim 1, wherein a volume of the tissue (200) is 1 cm³ or more.

4. The system of claim 1, wherein the tissue (200) is from 0.5 cm³ to 2 cm³.

5. The system of claim 1, wherein the fluorescence light sheet microscope (1000) is a Zeiss Z1 Fluorescence Light Sheet Microscope.

6. The system of claim 1, wherein the system (100) increases imaging speed for large samples.

7. The system of claim 6, wherein the system (100) increases imaging speed for large samples through the use of low magnification detection objectives.

8. The system of claim 1, wherein the system (100) improves optical sectioning in high refractive index solutions.

9. The system of claim 1, wherein the system (100) has an increased chamber volume as compared to traditional chambers.

10. The system of claim 1, wherein the system (100) has an increased detection path focal length to increase size of specimens that can be imaged.

11. A specimen imaging system (100) for use in a Zeiss Z1 Fluorescence Light Sheet Microscope for producing an image of a specimen (200) in a solution (210) with a refractive index>=1.45, the system (100) comprising:
a. a specimen chamber (1) for accommodating a tissue (200), wherein the tissue (200) is approximately 1 cm³ in size;
b. a first and second side window (2) for a light sheet, wherein the side windows (2) are spaced to center a beam waist of the light sheet at a focal plane of a detection optic;
c. a chamber positioning mechanism (4) for facilitating adjustment of an imaging objective focal plane according to the refractive index of the high refractive index solution (210);
d. a specimen holder (5) for suspending the tissue (200) within the chamber (1); and
e. a detection objective collar (7) for repositioning an objective's focal plane to increase imaging range and match a light sheet focal plane, wherein the collar (7) also prevents accidental collision with the specimen chamber (1) during positioning.

12. The system of claim 11, wherein the system (100) improves optical sectioning in high refractive index solutions.

13. The system of claim 11, wherein the system (100) has an increased detection path focal length to increase size of specimens that can be imaged.

14. A method of light sheet fluorescence microscopy for imaging a biological specimen (200) in a high refractive index solution (210), the method comprising:
a. providing a light sheet fluorescence microscope (1000) comprising a high refractive index specimen imaging system (100), the system comprising:
i. a specimen chamber (1) for accommodating a tissue (200),
ii. a first and second side window (2) positioned on either side of the specimen chamber (1),
iii. a chamber positioning mechanism (4) operatively connected to the specimen chamber (1) for facilitating adjustment of an imaging objective focal plane,
iv. a specimen holder (5) removably positioned above the specimen chamber (1) for suspending the tissue (200) within the chamber (1), and
v. a detection objective collar (7) for repositioning an objective focal plane;
b. providing a biological specimen (200);
c. disposing the biological specimen (200) within a specimen holder (5);
d. filling a specimen chamber (1) with an aqueous solution (210) with a refractive index>=1.45;
e. actuating a chamber positioning screw (4) to adjust an imaging objective focal plane according to the refractive index of the aqueous solution (210);
f. lowering the specimen holder (5) into the specimen chamber (1);
g. actuating the light sheet fluorescence microscope (1000) such that a sheet of light is propagated through a first and a second side window (2) and through an entirety of the biological specimen (200);
h. repositioning, by a detection objective collar (7), a detection objective focal plane to increase imaging range and match the refractive index of the aqueous solution (210).

15. The method of claim 14, wherein the biological specimen (200) is 1 cm³ or more in size.

16. The method of claim 14, wherein the biological specimen (200) is between 0.5 cm³ to 2 cm³ in size.

17. The method of claim 14, wherein the light sheet fluorescence microscope (1000) is a Zeiss Z1 Fluorescence Light Sheet Microscope.

18. The method of claim 14, wherein the light sheet fluorescence microscope (1000) facilitates use of low magnification detection objectives.

19. The method of claim 14, wherein the high refractive index imaging system (100) improves optical sectioning in high refractive index solutions.

20. The method of claim 14, wherein the high refractive index imaging system (100) has an increased detection path focal length to increase size of specimens that can be imaged.
